(19) United States
(12) Patent Application Publication
(10) Pub. No.: US 2013/0336381 A1
(43) Pub. Date: Dec. 19, 2013

(54) VIDEO TRANSMISSION SYSTEM AND TRANSMITTING DEVICE AND RECEIVING DEVICE THEREOF

(71) Applicant: QUANTA COMPUTER INC., Tao Yuan Shien (TW)

(72) Inventors: Kai-Ju CHENG, Taoyuan County (TW); Rong-Quen CHEN, Taipei City (TW); Chih-Yin LIN, Taipei City (TW)

(73) Assignee: Quanta Computer Inc., Tao Yuan Shien (TW)

(21) Appl. No.: 13/672,769

(22) Filed: Nov. 9, 2012

(30) Foreign Application Priority Data
Jun. 19, 2012 (TW) 101121957

(51) Int. Cl. H04N 7/12

(52) U.S. Cl. CPC H04N 19/00006
USPC 375/240.02

(57) ABSTRACT

An image transmission system is provided. The image transmission system includes a transmitting device and a receiving device which are mutually connected via a number of communication links. The transmitting device receives an original image data, and obtains a region of interest (ROI) image data from the original image data in response to an ROI information. The transmitting device further provides two independent process channels respectively processing the original image data and the ROI image data, and respectively outputting the processed original image data and the processed ROI image data via the communication links. The receiving device receives and combines the processed original image data and the ROI image data to obtain a recovered frame image data.

This application claims the benefit of Taiwan application Serial No. 101121957, filed Jun. 19, 2012, the subject matter of which is incorporated herein by reference.

### BACKGROUND OF THE INVENTION

1. Field of the Invention

The invention relates in general to an image transmission system, and more particularly to an image transmission system using a number of data streams to respectively transmit an original image data and a region of interest (ROI) image data.

2. Description of the Related Art

Along with the advance in technology, image capturing, processing and transmitting technologies are provided and widely used in image processing and transmitting applications such as the third or fourth generation mobile telecommunication, video call, Internet video conferencing, instant messaging video, Internet audio and video interface or remote image security/monitoring system. As the consumers' expectations of audio/video quality are getting higher and higher, how to effectively transmit image data with superior quality under the restriction of limited frequency band in transmission has become a prominent task for the industries.

### SUMMARY OF THE INVENTION

According to a first aspect of the present invention, a transmitting device, including a signal source unit, a storage unit, an image processing unit, first and second encoding units and a transmitting unit, is provided. The signal source unit provides original image data. The image processing unit receives original image data, and obtains a region of interest (ROI) image data from the original image data in response to an ROI information and stores the ROI image data to the storage unit. The first encoding unit accesses an original image data from the signal source unit, and accordingly encodes the original image data to generate a first image stream data. The second encoding unit accesses an ROI image data from the storage unit, and accordingly encodes the ROI image data to generate a second image stream data. The second image stream data has reference time column information and space column information, respectively indicating the corresponding time domain vs. space domain relationship between the ROI image data and the original image data. The transmitting unit receives the first and the second image stream data, and respectively transmits the first and the second image stream data via the first and the second communication links.

According to a second aspect of the present invention, a receiving device is provided. The receiving device includes a first buffer, a second buffer, a receiving unit, a first decoding unit, a second decoding unit, an image selection unit and an image processing unit. The receiving unit respectively receives the first and the second image stream data via the first and the second communication links, and respectively stores the first and the second image stream data to the first and the second buffer. The first decoding unit accesses a first image stream data from the first buffer, and accordingly decodes the first image stream data to generate and temporarily stores a recovered original image data. The second decoding unit accesses a second image stream data from the second buffer, and accordingly decodes the second image stream data to generate and temporarily stores an ROI image data. The second image stream data has recovered reference time column information and recovered space column information, respectively indicating the corresponding time domain vs. space domain relationship between the recovered ROI image data and the recovered original image data. The image selection unit accesses a selective recovered frame image and a selective recovered ROI image from the first and the second decoding units in response to the recovered reference time column information information and the recovered space column information. The image processing unit receives and combines the selective recovered frame image and the selective recovered ROI images to accordingly obtain a recovered frame image data.

According to a third aspect of the present invention, an image transmission system is provided. The image transmission system includes a transmitting device and the receiving device as disclosed above.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of an image transmission system according to an embodiment of the invention;

FIG. 2 shows a block diagram of a transmitting device according to an embodiment of the invention;

FIG. 3 shows a block diagram of a receiving device according to an embodiment of the invention; and

FIG. 4 shows a schematic diagram of the operations of an image selection unit.

### DETAILED DESCRIPTION OF THE INVENTION

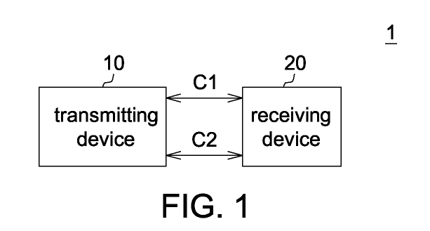

Referring to FIG. 1, a block diagram of an image transmission system according to an embodiment of the invention is shown. The image transmission system 1 of the present embodiment includes a transmitting device 10 and a receiving device 20, which are mutually connected via communication links C1 and C2 for performing communication operation. The communication links C1 and C2 may respectively be realized by a physical circuit interfaced by such as an A/V terminal, a D-sub connection port, a DVI connection port, an HDMI connection port, a DisplayPort connection port, a USB connection port, an RJ-45 connection port, or may respectively be realized by a non-physical channel such as a wireless network or a mobile communication system channel. In addition, the communication links C1 and C2 may selectively be realized by different channels. For example, one of the communication links C1 and C2 is realized by a USB physical channel and the other of the communication links C1 and C2 is realized by a wireless network.

### Transmitting Device:

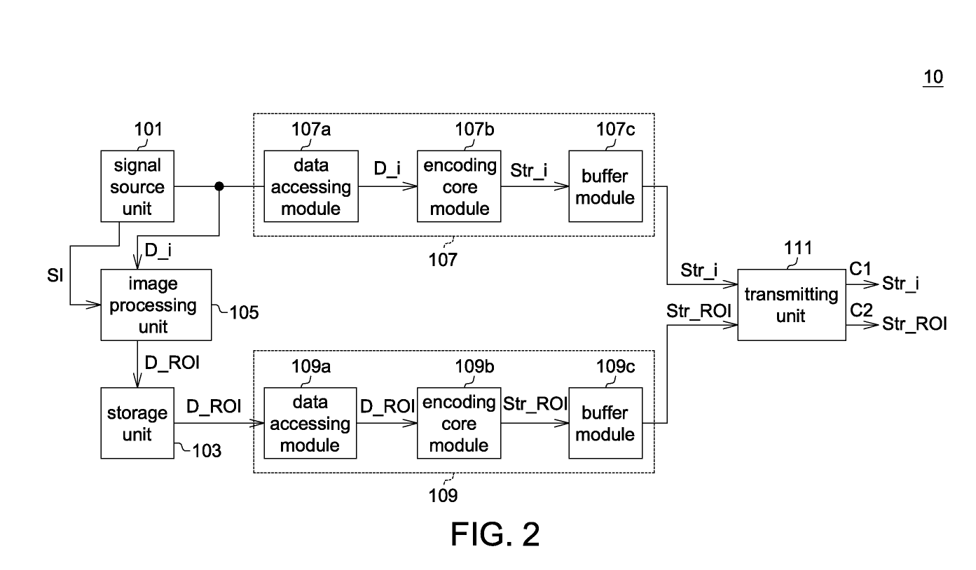

Referring to FIG. 2, a block diagram of a transmitting device according to an embodiment of the invention is shown. For example, the transmitting device 10 includes a signal source unit 101, a storage unit 103, an image processing unit 105, encoding units 107 and 109 and a transmitting unit 111. The signal source unit 101, realized by such as an image data capturing device or an image data receiving device, correspondingly captures or receives an original image and provides an original image data D_i. For example, the signal source unit 101 may be realized by an image data capturing device, such as a video recorder and a handheld camera, or may be realized by an image data receiving device, such as an image signal connection port and a network controller.

The image processing unit 105 is coupled to the signal source unit 101 and the storage unit 103 respectively. The image processing unit 105 receives the original image data D_i, and, in response to a region of interest (ROI) information SI, obtains an ROI image data D_ROI from the original image data D_i and then stores the ROI image data D_ROI to the storage unit 103. For example, the ROI image data D_ROI is image data, corresponding to the ROI region, copied from the original image data D_i. Thus, the content of the image data which corresponds to the ROI region of the original image data D_i is stored to both the signal source unit 101 and the storage unit 103 at the same time.

In a practical embodiment, the ROI information SI is user defined (i.e. user defined region) and is provided to the image processing unit 105 via a signal source unit 101. For example, the user could correspondingly defines the center region of the original image data D_i as an ROI region.

In a practical embodiment such as a video call or an Internet video conferencing, the ROI information SI may selectively define the facial image region, the center region or the focusing depth region of the original image data D_i as an ROI region. Then, the image processing unit 105 recognizes the facial image region, the center region or the focusing depth region to obtain or generate an ROI image data.

In a practical embodiment such as a remote image monitoring system, the ROI information SI corresponding to the region in the original image data D_i with largest variation (such as the variation between subsequent frame images) is defined as an ROI region, and the image processing unit 105 searches for the region with largest variation to obtain or generate an ROI image data.

The encoding unit 107 accesses the original image data D_i from the signal source unit 101 and accordingly encodes the data to generate an image stream data Str_i. For example, the encoding unit 107 may be realized by any existing image compressing, encoding or processing unit used for compressing, encoding or processing the original image data D_i. To put it in greater details, the encoding unit 107 includes a data accessing module 107a, an encoding core module 107b and a buffer module 107c respectively accesses each frame image data from the original image data D_i, encodes the frame image data and temporarily stores the data obtained from associated operations.

For example, the original image data D_i includes an original time column information correspondingly indicating the time index value of each frame image data of the original image data D_i. The encoding unit 107, selectively in response to the original time column information of the original image data D_i or the frame index information generated in the encoding operation, sets the time column information in each frame image data of the image stream data Str_i.

The encoding unit 109 accesses the ROI image data D_ROI from the storage unit 103 and accordingly encodes the data to generate an image stream data Str_ROI. Like the encoding unit 107, the encoding unit 109 may also be realized by any existing image compressing, encoding or processing unit used for performing corresponding processing operation on the ROI image data D_ROI. The encoding unit 109 correspondingly has a data accessing module 109a, an encoding core module 109b and a buffer module 109c.

Since the ROI image data D_ROI is copied from the original image data D_i by the image processing unit 105, the ROI image data D_ROI may also include a reference time column information corresponding to the original time column information and indicating the time index value of each ROI image data of the ROI image data D_ROI. In addition, the ROI image data D_ROI further includes a space column information indicating the pixel coordinate relationship between each ROI image data and each frame image data of the original image data. In other words, the ROI image data D_ROI includes a reference time column information and a space column information respectively indicating the time domain vs. space domain relationship between each ROI image data of the ROI image data D_ROI and each frame image data of the original image data D_i.

The encoding unit 109, selectively in response to the reference time column information of the ROI image data D_ROI or the frame timing index information generated during the encoding operation, sets the reference time column information and the space column information in each ROI image data of the image stream data Str_ROI.

In a preferred embodiment. The encoding units 107 and 109 are realized by two completely independent hardware modules and are respectively used for processing the original image data D_i and the ROI image data D_ROI via two completely independent circuit sets.

The transmitting unit 111 receives the image stream data Str_i and Str_ROI generated by the encoding units 107 and 109, and transmits the image stream data Str_i and Str_ROI via the communication links C1 and C2 respectively. Thus, the transmitting device 10 may effectively transmit the original image data D_i provided by the signal source unit 101 via the communication link C1, and additionally transmit the corresponding ROI image data D_ROI of the original image data D_i via the communication link C2 at the same time. The communication links C1 and C2 may go with any existing image data transmission interfaces or protocols. In short, the image stream data Str_i and Str_ROI are provided by the transmitting device 10 via two completely independent stream channels, and may also be separately transmitted via completely different transmission channels.

Since the transmitting device 10 generates the image stream data Str_i and Str_ROI via two completely independent stream channels, the encoding units 107 and 109 may be realized by two encoders having different compression ratios or different processing mechanisms. In comparison to the encoding unit 107, the encoding unit 109 is equipped with an error correction mechanism having higher computation capacity or an image processing mechanism having lower compression ratio and higher image recovery quality, so that the ROI image data is equipped with an image processing mechanism having higher computation load to correspondingly provide an ROI image data D_ROI with superior quality.

In the present embodiment, the original image data D_i and the ROI image data D_ROI are stored to the signal source unit 101 and the storage unit 103 respectively, and the encoding units 107 and 109 access and encode the image data of the signal source unit 101 and the storage unit 103 respectively, but the transmitting device 10 of the present embodiment is not limited thereto.

In other example, the transmitting device 10 of the present embodiment may do without the storage unit 103, and the encoding unit 109 is coupled to the signal source unit 101 through the image processing unit 105. Meanwhile, the image processing unit 105, in response to the ROI information SI, may adjust the setting of the memory access pointer when the encoding unit 109 accesses the signal source unit 101. Thus, through the setting of the memory access pointer of the image processing unit 105, the encoding units 107 and 109 may respectively access the original image data D_i and the ROI image data D_ROI from the signal source unit 101 and correspondingly encode the original image data without using the storage unit 103.

### Receiving Device:

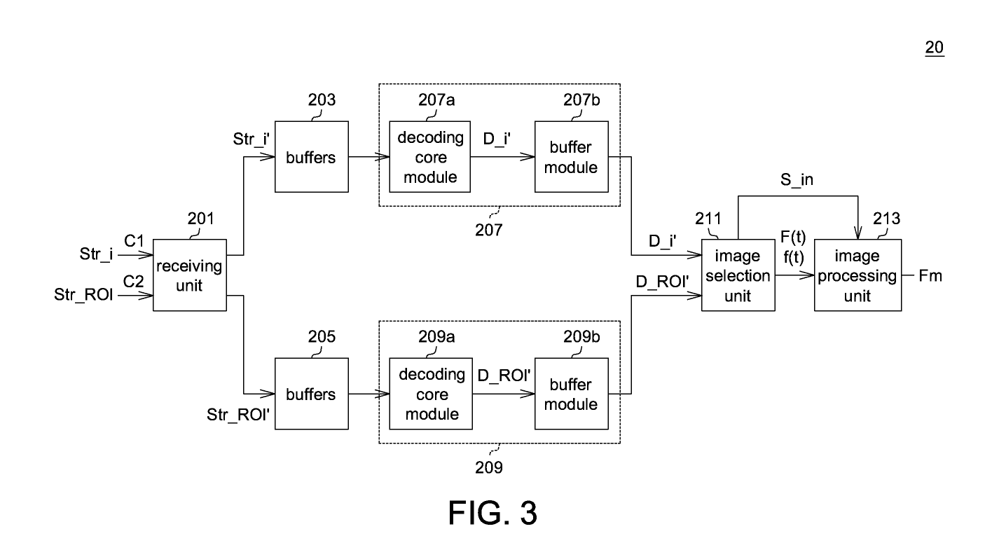

Referring to FIG. 3, a block diagram of a receiving device according to an embodiment of the invention is shown. For example, the receiving device 20 includes a receiving unit 201, buffers 203 and 205, decoding units 207 and 209, an image selection unit 211 and an image processing unit 213.

The receiving unit 201 communicates with the transmitting unit 111 via the communication links C1 and C2 to correspondingly receive and store the image stream data Str_i′ and Str_ROI′ to the buffers 203 and 205 respectively. Ideally, the communication links C1 and C2 are ideal transmitting channels, and the image stream data Str_i′ and Str_ROI′ received by the receiving unit 201 respectively are equal to the image stream data Str_i and Str_ROI provided by the transmitting unit 111.

The decoding unit 207 accesses the image stream data Str_i′ stored in the buffer 203, and accordingly decodes the data to generate a recovered original image data D_i′. For example, the decoding unit 207 includes a decoding core module 207a and a buffer module 207b, wherein the decoding core module 207a, equipped with decoding capability corresponding to the encoding core module 107b, obtains a recovered original image data D_i′ by way of decoding and further stores the recovered original image data D_i′ to the buffer module 207b.

The decoding unit 209 accesses the image stream data Str_ROI′ stored in the buffer 205, and accordingly decodes the data to generate a recovered ROI image data D_ROI′. Similarly, the decoding unit 209 includes a decoding core module 209a and a buffer module 209b, wherein the decoding core module 209a, equipped with a decoding capability corresponding to the encoding core module 109b, obtains a recovered ROI image data D_ROI′ by way of decoding and further stores the recovered ROI image data D_ROI′ to the buffer module 209b.

In addition, the decoding units 207 and 209 further locate and store the original time column information of each frame image data contained in the image stream data Str_i′ and Str_ROI′ as well as the reference time column information and space column information of each ROI image data to the recovered original image data D_i′ and the recovered ROI image data D_ROI′ respectively. The recovered original time column information (located in the recovered original image data D_i′) and the recovered reference time column information (located in the recovered ROI image data D_ROI′) correspond to each other and indicate the time index value of each recovered frame image data of the recovered original image data D_i′ and the time index value of each recovered ROI image data of the recovered ROI image data D_ROI′ respectively. In addition, the recovered ROI image data D_ROI′ further has a recovered space column information. Thus, the corresponding time domain vs. space domain relationship between each recovered ROI image data and each corresponding recovered frame image data is indicated.

The image selection unit 211, in response to the recovered original time column information, the recovered reference time column information and the recovered space column information, accesses a selective recovered frame image and a selective recovered ROI image corresponding to the same time index value from the buffer modules 207b and 209b.

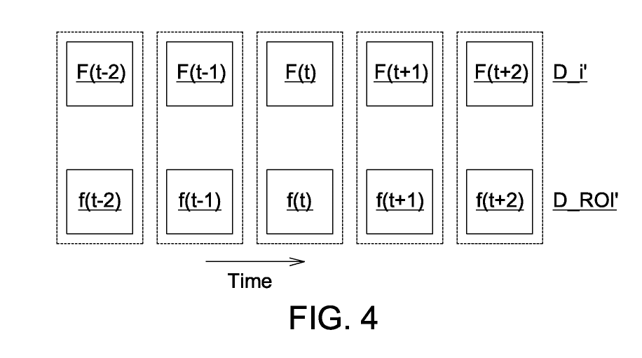

Referring to FIG. 4, a schematic diagram of the operations of an image selection unit 211 is shown. For example, at a particular operating time point, the buffer module 207b temporarily stores 5 pieces of recovered frame image data F(t−2), F(t−1), F(t), F(t+1) and F(t+2) of the recovered original image data D_i′, wherein the recovered original time column information respectively corresponds to time index values t−2, t−1, t, t+1 and t+2, and t is a natural number larger than or equal to 2. Similarly, the buffer module 209b temporarily stores 5 pieces of recovered ROI image data f(t−2), f(t−1), f(t), f(t+1) and f(t+2) of the recovered ROI image data D_ROI′, wherein the recovered reference time column information corresponds to time index values t−2, t−1, t, t+1 and t+2 respectively.

In the present operating example, the image selection unit 211, in response to the recovered original time column information of each of the recovered frame image data F t−2)˜F(t+2) and the recovered reference time column information of each of the recovered ROI image data f(t−2)˜f(t+2), locates a selective recovered frame image and a selective recovered ROI image. The selective recovered frame image and the selective recovered ROI image correspond to the same time index value, and are realized by such as the recovered frame image data F(t) and the recovered ROI image data f(t).

The image processing unit 213 receives and combines the selective recovered frame image and the selective recovered ROI image according to the recovered space column information to obtain a recovered frame image data Fm. For example, the image processing unit 213 combines the two pieces of image data by replacing the region, corresponding to the region of the selective recovered ROI image data, of the selective recovered frame image data, wherein the information of the covered region is provided by the recovered space column information. The image processing unit 213 further performs smoothing operation on the recovered frame image data Fm.

Through the above operations, the receiving device 20 of the present embodiment may effectively receive the image stream data Str_i′ and Str_ROI′ provided by the transmitting device 10 via the communication links C1 and C2, and accordingly combine the data to obtain a recovered frame image data Fm.

The present embodiment is exemplified by the selection of image data by the image selection unit 211 as indicated in FIG. 4, but the image selection unit 211 of the present embodiment is not limited thereto. In other examples, the image selection unit 211 further provides a state indicating signal S_in to notice the image processing unit 213 whether data loss occurs to the recovered original image data D_i′ and the recovered ROI image data D_ROI′, and instructs the image processing unit 213 to obtain a recovered frame image data Fm by different image processing methods.

To put it in greater details, when the recovered original image data D_i′ and the recovered ROI image data D_ROI′ are free of data loss, the state indicating signal S_in corresponds to a pre-determined value. The image processing unit 213, in response to the state indicating signal S_in of the pre-determined value, executes the abovementioned operation of combining the selective recovered frame image and the selective recovered ROI image corresponding to the same time index value to obtain a recovered frame image data Fm.

Relatively, when the recovered frame image data F(t) corresponding to the time index value t is lost from the recovered original image data D_i′, the image selection unit 211 outputs the state indicating signal S_in corresponding to the first state value, and selectively chooses the recovered frame image data (that is, F(t−1) or F(t+1)) corresponding to the previous or the next time index value as a selective recovered frame image. Thus, the image processing unit 213, in response to the state indicating signal S_in corresponding to the first state value, combines the selective recovered frame image (such as F(t−1) or F(t+1)) and the selective recovered ROI image f(t) corresponding to different time index values to obtain a recovered frame image data Fm. In addition, the image processing unit 213 further selectively and additionally performs a repair operation such as moving compensation on the selective recovered frame image.

Relatively, when the recovered ROI image data f(t) corresponding to the time index value t is lost from the recovered ROI image data D_ROI′, the image selection unit 211 outputs a state indicating signal S_in corresponding to the second state value. Thus, the image processing unit 213, in response to the state indicating signal S_in corresponding to the second state value, directly uses the selective recovered frame image (such as F(t)) as a recovered frame image data Fm. In other words, under the circumstance that the recovered ROI image data f(t) is lost, the image processing unit 213 correspondingly ignores the operation of combining the selective recovered frame image and the selective recovered ROI image, and outputs the selective recovered frame image.

The image transmission system of the present embodiment includes a transmitting device and a receiving device, which are mutually connected via a number of communication links. The transmitting device encodes and transmits the original image data and the ROI image data via two completely independent image data process channels. The receiving device receives an original image data stream and an ROI image data stream via the communication links, and correspondingly decodes and receives the data via the two completely independent image data process channels. In comparison to the conventional image transmission system, the image transmission system of the present embodiment has the advantages of independently transmitting the original image and the ROI image, and effectively improving the image display quality for the ROI region of the original image without largely increasing data transmission volume.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transmitting device, comprising:
a signal source unit used for providing an original image data;
an image processing unit, which receives the original image data and obtains a region of interest (ROI) image data from the original image data in response to an ROI information;
a first encoding unit, which accesses the original image data and accordingly encodes the original image data to generate a first image stream data;
a second encoding unit, which accesses the ROI image data and accordingly encodes the ROI image data to generate a second image stream data, wherein the second image stream data has a reference time column information and a space column information respectively indicating the corresponding time domain vs. space domain relationship between the ROI image data and the original image data; and
a transmitting unit, which receives the first and the second image stream data and transmits the first and the second image stream data via a first communication link and a second communication link respectively.

2. The transmitting device according to claim 1, wherein the original image data comprises an original time column information indicating the index value of each frame image of the original image data.

3. The transmitting device according to claim 2, wherein the image processing unit generates the reference time column information in response to the original time column information, and the reference time column information corresponds to the original time column information and indicates the index value of each ROI image of the ROI image data.

4. A receiving device, comprising:
a first buffer and a second buffer;
a receiving unit, which receives a first image stream data and a second image stream data via a first communication link and a second communication link respectively and stores the first and the second image stream data to the first and the second buffers respectively;
a first decoding unit, which accesses the first image stream data from the first buffer and accordingly decodes the first image stream data to generate and temporarily store a recovered original image data;
a second decoding unit, which accesses the second image stream data from the second buffer and accordingly decodes the second image stream data to generate and temporarily store a recovered region of interest (ROI) image data, wherein the second image stream data has a recovered reference time column information and a recovered space column information respectively indicating the corresponding time domain vs. space domain relationship between the recovered ROI image data and the recovered original image data;
an image selection unit, which accesses a selective recovered frame image and a selective recovered ROI image from the first and the second decoding units in response to the recovered reference time column information and the recovered space column information, wherein the selective recovered frame image and the selective recovered ROI image correspond to each other; and
an image processing unit, which receives and combines the selective recovered frame image and the selective recovered ROI image to obtain a recovered frame image data.

5. The receiving device according to claim 4, wherein the recovered original image data comprises a recovered original time column information indicating the index value of each recovered frame image of the recovered original image data.

6. The receiving device according to claim 5, wherein the image processing unit generates the recovered reference time column information in response to the recovered original time column information, and the recovered reference time column information corresponds to the recovered original time column information and indicates the index value of each recovered ROI image of the recovered ROI image data.

7. An image transmission system, comprising:
a transmitting device, comprising:
a signal source unit used for providing an original image data;
a storage unit;
a first image processing unit, which receives the original image data and obtains a region of interest (ROI) image data from the original image data in response to an ROI information, wherein the image processing unit further stores the ROI image data to the storage unit;
a first encoding unit, which accesses the original image data from the signal source unit and accordingly encodes the original image data to generate a first image stream data;
a second encoding unit, which accesses the ROI image data from the storage unit and accordingly encodes the ROI image data to generate a second image stream data, wherein the second image stream data has a reference time column information and a space column information respectively indicating the corresponding time domain vs. space domain relationship between the ROI image data and the original image data; and
a transmitting unit, which receives the first and the second image stream data and respectively transmits the first and the second image stream data via a first communication link and a second communication link; and
a receiving device, which is coupled to the transmitting device via the first and the second communication links and comprises:
a first buffer and a second buffer;
a receiving unit, which receives the first and the second image stream data via the first and the second communication links respectively and stores the first and the second image stream data to the first and the second buffers respectively;
a first decoding unit, which accesses the first image stream data from the first buffer and accordingly decodes the first image stream data to generate and temporarily store a recovered original image data;
a second decoding unit, which accesses the second image stream data from the second buffer and accordingly decodes the second image stream data to generate and temporarily store a recovered ROI image data, wherein the second image stream data has a recovered reference time column information and a recovered space column information respectively indicating the corresponding time domain vs. space domain relationship between the recovered ROI image data and the recovered original image data;
an image selection unit, which accesses a selective recovered frame image and a selective recovered ROI image, in response to the recovered reference time column information and the recovered space column information, from the first and the second decoding units respectively, wherein the selective recovered frame image corresponds to the selective recovered ROI image; and
an image processing unit, which receives and accordingly combines the selective recovered frame image and the selective recovered ROI image to obtain a recovered frame image data.

8. The image transmission system according to claim 7, wherein the original image data comprises an original time column information indicating the index value of each frame image of the original image data.

9. The image transmission system according to claim 8, wherein the first image processing unit generates the reference time column information in response to the original time column information, and the reference time column information corresponds to the original time column information and indicates the index value of each ROI image of the ROI image data.

10. The image transmission system according to claim 9, wherein the recovered original image data comprises a recovered original time column information corresponding to the original time column information and indicating the index value of each recovered frame image of the recovered original image data.

11. The image transmission system according to claim 10, wherein the recovered reference time column information corresponds to the recovered original time column information and indicates the index value of each recovered ROI image of the recovered ROI image data.
